(19) United States
(12) Patent Application Publication
(10) Pub. No.: US 2020/0311855 A1
(43) Pub. Date: Oct. 1, 2020

(54) OBJECT-TO-ROBOT POSE ESTIMATION FROM A SINGLE RGB IMAGE

(71) Applicant: NVIDIA Corporation, Santa Clara, CA (US)

(72) Inventors: Jonathan Tremblay, Redmond, WA (US); Stephen Walter Tyree, St. Louis, MO (US); Stanley Thomas Birchfield, Sammamish, WA (US)

(21) Appl. No.: 16/902,097

(22) Filed: Jun. 15, 2020

Related U.S. Application Data
(63) Continuation-in-part of application No. 16/657,220, filed on Oct. 18, 2019.
Application No. 16/657,220 is a continuation-in-part of application No. 16/405,662, filed on May 7, 2019.
(60) Provisional application No. 62/672,767, filed on May 17, 2018.

(51) Int. Cl. G06T 1/00; G06K 9/00; G06K 9/20; G06K 9/62

(52) U.S. Cl. CPC G06T 1/0014; G06K 9/00664; G06K 9/6202; G06K 9/6256; G06K 9/2018

(57) ABSTRACT

Pose estimation generally refers to a computer vision technique that determines the pose of some object, usually with respect to a particular camera. Pose estimation has many applications, but is particularly useful in the context of robotic manipulation systems. To date, robotic manipulation systems have required a camera to be installed on the robot itself (i.e. a camera-in-hand) for capturing images of the object and/or a camera external to the robot for capturing images of the object. Unfortunately, the camera-in-hand has a limited field of view for capturing objects, whereas the external camera, which may have a greater field of view, requires costly calibration each time the camera is even slightly moved. Similar issues apply when estimating the pose of any object with respect to another object (i.e. which may be moving or not). The present disclosure avoids these issues and provides object-to-object pose estimation from a single image.

### CLAIM OF PRIORITY

This application is a continuation-in-part of U.S. application Ser. No. 16/405,662 (Reference: 741851/18-RE-0161-US02), filed May 7, 2019 and entitled “DETECTING AND ESTIMATING THE POSE OF AN OBJECT USING A NEURAL NETWORK MODEL,” which claims priority to U.S. Provisional Application No. 62/672,767 (Reference: 18-RE-0161US01), filed May 17, 2018 and entitled “DETECTION AND POSE ESTIMATION OF HOUSEHOLD OBJECTS FOR HUMAN-ROBOT INTERACTION,” which are herein incorporated by reference in its entirety.

This application is a continuation-in-part of U.S. application Ser. No. 16/657,220 (Reference: 1R2674.006901/19-SE-0341US01), filed Oct. 18, 2019 and entitled “POSE DETERMINATION USING ONE OR MORE NEURAL NETWORKS,” which is herein incorporated by reference in its entirety.

### TECHNICAL FIELD

The present disclosure relates to pose estimation systems and methods.

### BACKGROUND

Pose estimation generally refers to a computer vision technique that determines the Euclidean position and orientation of some object, usually with respect to a particular camera. Pose estimation has many applications, but is particularly useful in the context of robotic manipulation systems. To date, robotic manipulation systems have required a camera to be installed on the robot itself (i.e. a camera-in-hand) for capturing images of the object and/or a camera external to the robot for capturing images of the object. In both cases, the camera must be calibrated with respect to the robot in order to then estimate pose of a captured object with respect to the robot.

While calibration of the camera-in-hand may only be required to be performed once to determine the position of the camera with respect to the robot, due to the rigid installation of the camera on the robot, this camera has a limited field of view thus preventing it from seeing a surrounding context and being able to easily adapt when the object is moved out of the camera's field of view. On the other hand, while the external camera may have a greater field of view, which may optionally supplement the camera-in-hand, the external camera requires calibration each time the camera is even slightly moved. Calibration, however, is typically an offline process that is tedious, sensitive, and error-prone. While these issues are described particularly with respect to robotic manipulation systems, it should be noted that the same limitations apply to any pose estimation system operable to estimate the pose of one object with respect to another object (i.e. which may be moving or not).

There is a need for addressing these issues and/or other issues associated with the prior art.

### SUMMARY

A method, computer readable medium, and system are disclosed for object-to-object pose estimation from an image. In use, an image of a first object and a target object is identified, where the image is captured by a camera external to the first object and the target object. Additionally, the image is processed, using a first neural network, to estimate a first pose of a target object with respect to the camera. Further, the image is processed, using a second neural network, to estimate a second pose of the first object with respect to the camera. Still yet, a third pose of the first object with respect to the target object is calculated, using the first pose and the second pose.

### BRIEF DESCRIPTION OF THE DRAWINGS

FIG. 1 illustrates a method for object-to-object pose estimation from an image, in accordance with an embodiment.

FIG. 2 illustrates a system for object-to-object pose estimation from an image, in accordance with an embodiment.

FIG. 3 illustrates a block diagram associated with the first neural network of FIG. 2, in accordance with an embodiment.

FIG. 4 illustrates a block diagram associated with the second neural network of FIG. 2, in accordance with an embodiment.

FIG. 5 illustrates a robotic grasping system controlled using a robot-to-object pose estimation system, in accordance with an embodiment.

FIG. 6A illustrates inference and/or training logic, according to at least one embodiment.

FIG. 6B illustrates inference and/or training logic, according to at least one embodiment.

FIG. 7 illustrates training and deployment of a neural network, according to at least one embodiment.

FIG. 8 illustrates an example data center system, according to at least one embodiment.

### DETAILED DESCRIPTION

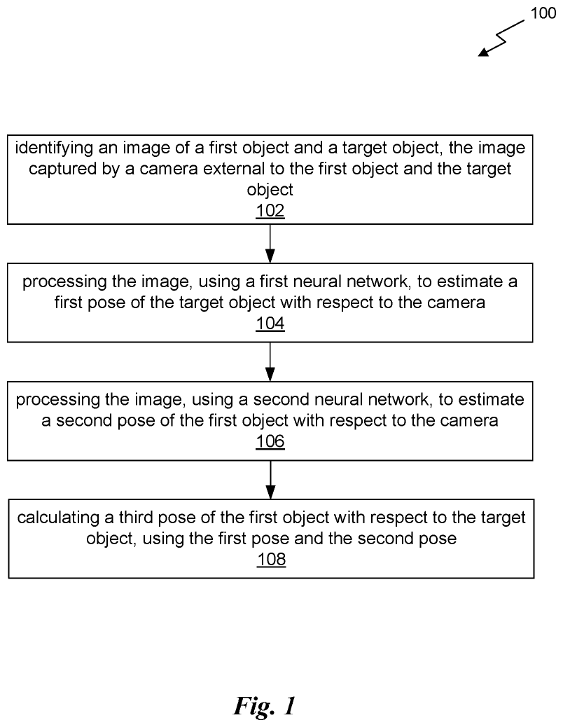

FIG. 1 illustrates a method 100 for object-to-object pose estimation from an image, in accordance with an embodiment. The method 100 may be carried out by any computing system, which may include one or more computing devices, one or more computer processors, non-transitory memory, circuitry, etc. In an embodiment, the non-transitory memory may store instructions executable by the one or more computing devices and/or or one or more computer processors to perform the method 100. In another embodiment, the circuitry may be configured to perform the method 100.

As shown in operation 102, an image of a first object and a target object is identified, where the image is captured by a camera external to the first object and the target object. In the context of the present description, the target object and the first object are separate physical objects (e.g. within some vicinity to each other). In one embodiment, the first object may be a robotic grasping system, having a robotic arm for grasping objects. In furtherance to this embodiment, the target object may be a known object to be grasped by the robotic grasping system. In another embodiment, the first object may be another autonomous object, such as an autonomous vehicle, that interacts with (or makes decisions in association with) a target object, such as another car. Of course, however, the first object and the target object may be any objects for which a pose between the two is desired (e.g. for computer vision applications).

As noted above, a camera external to the first object and the second object captures the image of the first object and the target object. With respect to the present description, the camera is external to the first object and the target object by being located independently of the first object and the target object. For example, the camera may not be installed on either of the first object or the target object. In one embodiment, the camera may be installed on a tripod or other rigid surface for capturing the image of the first object and the target object.

The image of the target object may be a red-green-blue (RGB) image, in one embodiment, or a grayscale image, in another embodiment. The image may, or may not, include depth. In another embodiment, the image may be a single image. In a further embodiment, the may be a combination. of images taken from various types of sensors, such as a six-channel image, which may include Red, Green, Blue, Infrared, Ultraviolet, and radar. Furthermore, the camera may be a monocular RGB camera. Of course, however, the camera may capture any number of channels of any wavelengths of light (visible to humans or not), and even non-light wavelengths. For example, the camera may utilize infrared, ultraviolet, microwave, radar, sonar, or other technology to capture images.

Additionally, as shown in operation 104, the image is processed, using a first neural network, to estimate a first pose of a target object with respect to the camera. The first neural network may be trained to output the 2-dimensional (2D) image locations (x,y coordinates) of keypoints on the target object. These 2D image locations, along with 3D coordinates of the target object model, may then used to estimate the pose of the target object with respect to the camera. In one embodiment, a PnP algorithm may be used to compute the pose of the target object with respect to the camera. In another embodiment, the first pose of the target object with respect to the camera may include a three-dimensional (3D) rotation and translation of the target object with respect to the camera.

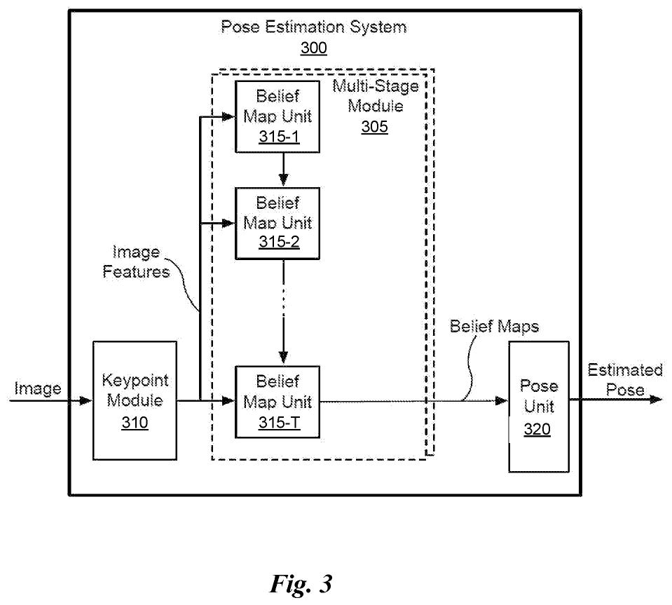

By way of example, the first neural network may be that disclosed in U.S. application Ser. No. 16/405,662 (Reference: 741851/18-RE-0161-US02), filed May 7, 2019 and entitled “DETECTING AND ESTIMATING THE POSE OF AN OBJECT USING A NEURAL NETWORK MODEL,” which is herein incorporated by reference in its entirety. More details regarding an embodiment of the first neural network will be described below with reference to FIG. 3.

Further, as shown in operation 106, the image is processed, using a second neural network, to estimate a second pose of the first object with respect to the camera. The second neural network may be trained to output the 2-dimensional (2D) image locations (x,y coordinates) of keypoints on the first object. These 2D image locations, along with 3D coordinates of the first object model, may then used to estimate the pose of the first object with respect to the camera. In one embodiment, a perspective-n-point (PnP) algorithm may be used to compute the pose of the first object with respect to the camera. In another embodiment, the second pose of the first object with respect to the camera may include a 3D rotation and translation of the first object with respect to the camera.

As an option, the second neural network may also perform online calibration of the camera. This online calibration may allow the camera to be moved during runtime, including for example during operation of the robotic grasping system or other autonomous system.

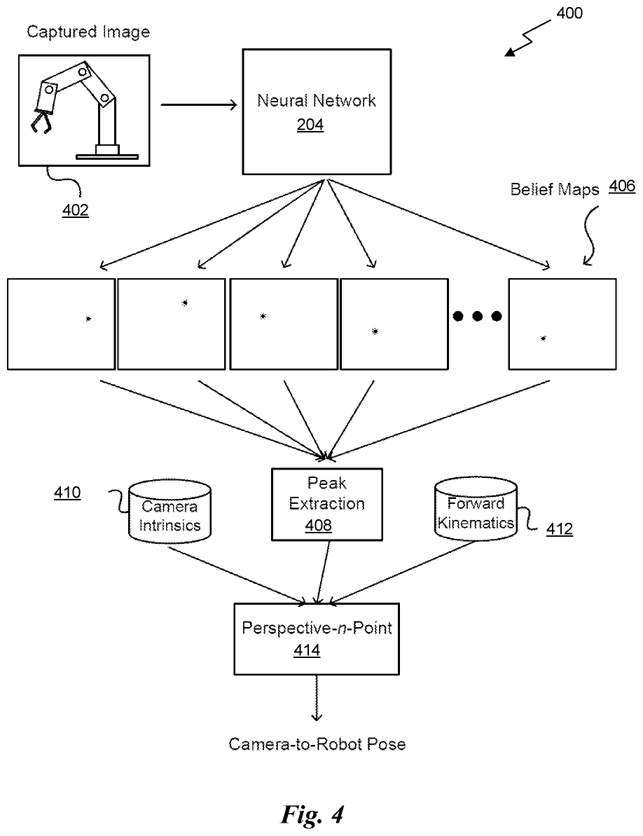

By way of example, the second neural network may be that disclosed in U.S. application Ser. No. 16/657,220 (Reference: 1R2674.006901/19-SE-0341US01), filed Oct. 18, 2019 and entitled “POSE DETERMINATION USING ONE OR MORE NEURAL NETWORKS,” which is herein incorporated by reference in its entirety. More details regarding an embodiment of the second neural network will be described below with reference to FIG. 4.

Still yet, as shown in operation 108, a third pose of the first object with respect to the target object is calculated, using the first pose and the second pose. Thus, a first object-to-target object pose estimation may be calculated. In one embodiment, the third pose may be a pose of the target object with respect to a coordinate frame of the first object. In another embodiment, the third pose may be calculated by multiplying the inverse of the output of one of the neural networks with the output of another one of the neural networks, such as the inverse the first pose multiplied by the second pose, or the inverse of the second pose multiplied by the first pose.

In the context of the first object being the robotic grasping system, the robotic grasping system may further be caused to grasp the target object (i.e. the known object), using the third pose. For example, the third pose may be provided to the robotic grasping system to enable the robotic grasping system to locate and grasp the target object. Of course, in other embodiments the third pose may be used for other purposes, including for example to control the autonomous car or cause the autonomous car to make a decision based on the relative location of the target object.

As an option, the first pose and/or the second pose may be refined, prior to calculating the third pose. For example, the first pose may be refined by iteratively matching the image with a synthetic projection of a model according to the first pose, and then adjusting parameters of the first pose based on a result of the iterative matching. Similarly, the second pose may be refined by iteratively matching the image with a synthetic projection of a model according to the second pose, and then adjusting parameters of the second pose based on a result of the iterative matching.

To this end, pose between the first object and the target object may be estimated using two neural networks. In particular, one neural network may estimate a first pose of the first object with respect to the camera, and the second neural network may estimate a second pose of the first object with respect to the camera. The output of the neural networks (i.e. the first pose and the second pose) may then be used as the basis for determining the pose between the first object and the target object.

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

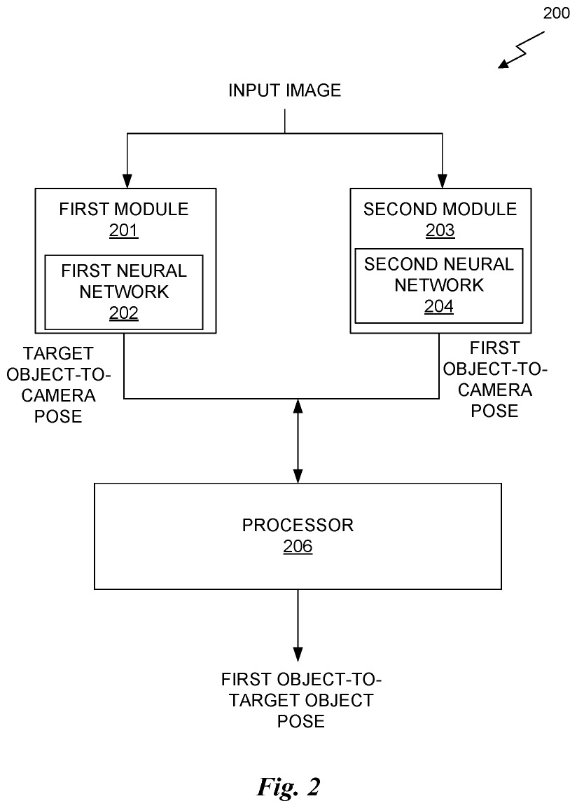

FIG. 2 illustrates a system 200 for object-to-object pose estimation from an image, in accordance with an embodiment. For example, the system 200 may implement the method 100 of FIG. 1. The system 200 may be located in the cloud, and thus remotely located with respect to the objects, in one embodiment. In another embodiment, the system 200 may be located in a computing device that is local to the objects.

As shown, the system 200 includes a first module 201 including a first neural network 202, a second module 203 including a second neural network 204, and a processor 206. An image is input to the first neural network 202 and the second neural network 204. The image is of a first object and a target object, and is captured by a camera external to both the first object and the target object. The camera may also be external to the system 200. However, the image may be provided by the camera to the system 200 via a network, shared memory, or in any other manner.

The first neural network 202 receives as input the image and processes the image to estimate a first pose of the target object with respect to the camera (i.e. the target object-to-camera pose). The first neural network 202 may be a deep neural network that estimates the 6-DoF pose (e.g. 3D rotation and translation) of known objects with respect to the camera. This network 202 may consist of a multiple stage convolutional network that transforms the input RGB image into a set of belief maps, one per keypoint. In one embodiment, n=9 keypoints are used to represent the vertices of a bounding cuboid, along with the centroid. In addition to the belief maps, the network 202 may output n−1 affinity maps, one for each non-centroid keypoint. Each map is a 2D field of unit vectors pointing toward the nearest object centroid. The maps may be used by a postprocessing step to individuate objects, allowing the system to handle multiple instances of each object. Pose may be determined by the first module 201 applying a PnP algorithm to the keypoints detected as peaks in the belief maps.

In one embodiment, the input to the network 202 may consist of 533×400 images processed by a VGG-based feature-extractor, resulting in a 50×50×512 block of features. These features may be processed by a series of 6 stages—each with 7 convolutional layers—which output and refine the belief maps described above.

The second neural network 204 receives as input the image and processes the image to estimate a second pose of the first object with respect to the camera (i.e. the first object-to-camera pose). In one embodiment, the second neural network 204 may be a deep neural network that estimates the 6-DoF pose of the robot with respect to the camera. This network 204 may consist of an encoder-decoder that transforms the input RGB image into a set of belief maps, one per keypoint. Because only one robot is in the scene, affinity fields may not be needed.

In one embodiment, the keypoints located at the joints of the robot may be defined to achieve pose stability when the arms are mostly out of the camera's field of view, which occurs when the camera is viewing the scene from a close range. In one embodiment, the input to the network 204 is a 400×400 image, downsampled and center cropped from the original 640×480. The layers of the network 204 may be as follows: the encoder follows the same layer structure as VGG, whereas the decoder is constructed from 4 upsample layers followed by 2 convolution layers resulting in the keypoint belief maps. The second module 203 may apply a PnP algorithm to the keypoints detected as peaks in the belief maps.

As an option, the first pose and/or the second pose may be refined, to reduce errors in the estimates due to limited training data and/or network capacity. This refinement may be performed by adjusting the pose parameters by iteratively matching the input image with a synthetic projection of the model according to the current pose.

Since the first neural network 202 a second neural network 204 do not require the output of one another, the first neural network 202 a second neural network 204 may or may not operate in parallel, as desired. The output of each of the first neural network 202 and the second neural network 204 is provided to the processor 206. The processor 206 calculates a third pose of the first object with respect to the target object, using the first pose and the second pose. The third pose may be calculated using Equation 1, which is set forth in accordance with one embodiment.

_{O}^{R}T=(_{R}^{C}T)⁻¹_{O}^{C}T

where _{O}^{R}T is the pose of the object in the robot frame, _{R}^{C}T is the pose of the robot in the camera frame (calculated by the second network 204), and _{O}^{C}T is the pose of the object in the camera frame (calculated by the first network 202).

In an exemplary embodiment where the first object is a robotic grasping system and the target object is a known object, the processor 206 may then cause the robotic grasping system to grasp the target object, using the third pose. The processor 206 may communicate with the robotic grasping system via a network, such as the Internet (e.g. when the system 200 is remotely located with respect to the objects) or Ethernet (e.g. when the system 200 is local with respect to the objects).

Since the first neural network 202 only estimates the pose of the target object with respect to the camera, only the first neural network 202 (and not necessarily the second neural network 204) may trained for the target object. In this manner, the target object may be “known” to the first neural network 202, or in other words may be a “known object.” Of course, the first neural network 202 may also be trained for other categories or types of target objects.

Similarly, since the second neural network 204 only estimates the pose of the first object with respect to the camera, only the second neural network 204 (and not necessarily the first neural network 202) may be trained for the first object. In other words, the first object may be “known” to the second neural network 204. It should be noted, however, that the second neural network 204 may also be trained for other objects (e.g. other robots or other autonomous objects).

To this end, in contrast to end-to-end learning, the modular approach presented in the present system 200 may allow the system to be repurposed without having to retrain all the networks. For example, to apply the system 200 to a new robot, only the second network 204 need to be retrained. Similarly, to apply the system 200 to new objects, only the first network 202 need to be trained for those objects, independent of the robot and of other objects. Moreover, this modular approach may facilitate testing and refinement of the individual components to ensure accuracy and reliability.

FIG. 3 illustrates a block diagram associated with the first neural network 202 of FIG. 2, in accordance with an embodiment. Of course, the block diagram is set forth as one possible embodiment associated with the first neural network 202 of FIG. 2. This embodiment is described in more detail in U.S. application Ser. No. 16/405,662 (Reference: 741851/18-RE-0161-US02), filed May 7, 2019 and entitled “DETECTING AND ESTIMATING THE POSE OF AN OBJECT USING A NEURAL NETWORK MODEL,” which is herein incorporated by reference in its entirety.

In the embodiment shown, the pose estimation system 300 includes a keypoint module 310, a set of multi-stage modules 305, and a pose unit 320. Although the pose estimation system 300 is described in the context of processing units, one or more of the keypoint module 310, set of multi-stage module 305, and a pose unit 320 may be performed by a program, custom circuitry, or by a combination of custom circuitry and a program. For example, the keypoint module 310 may be implemented by a GPU, CPU (central processing unit), or any processor capable of processing an image to generate keypoint data.

The pose estimation system 300 receives an image captured by a single camera. The image may include one or more objects for detection. In an embodiment, the image comprises color data for each pixel in the image without any depth data. The pose estimation system 300 first detects keypoints associated with the object and then estimates 2D projections of vertices defining a bounding volume enclosing the object associated with the keypoints. The keypoints may include a centroid of the object and vertices of a bounding volume enclosing the object. The keypoints are not explicitly visible in the image, but are instead inferred by the pose estimation system 300. In other words, an object of interest is visible in the image, except for portions of the object that may be occluded, and the keypoints associated with the object of interest are not explicitly visible in the image. The 2D locations of the keypoints are estimated by the pose estimation system 300 using only the image data. The pose unit 320 recovers a 3D pose of an object using the estimated 2D locations, camera intrinsic parameters, and dimensions of the object.

The keypoint module 310 receives an image including an object and outputs image features. In an embodiment, the keypoint module 310 includes multiple layers of a convolutional neural network (i.e. first network 202). In an embodiment, the keypoint module 310 comprises the first ten layers of the Visual Geometry Group (VGG-19) neural network that is pre-trained using the ImageNet training database, followed by two 3×3 convolution layers to reduce the feature dimension from 512 to 256, and from 256 to 128. The keypoint module 310 outputs 3 channels of features, one for each channel (e.g., RGB).

The image features are input to a set of multi-stage modules 305. In an embodiment, the set of multi-stage modules 305 includes a first multi-stage module 305 configured to detect a centroid of an object and additional multi-stage modules 305 configured to detect vertices of a bounding volume that encloses the object in parallel. In an embodiment, the set of multi-stage modules 305 includes a single multi-stage module 305 that is used to process the image features in multiple passes to detect the centroid and the vertices of the bounding volume serially. In an embodiment, the multi-stage modules 305 are configured to detect vertices without detecting the centroid.

Each multi-stage module 305 includes T stages of belief map units 315. In an embodiment, the number of stages is equal to six (e.g., T=6). The belief map unit 315-1 is a first stage, the belief map unit 315-2 is a second stage, and so on. The image features extracted by the keypoint module 310 are passed to each of the belief map units 315 within a multi-stage module 305. In an embodiment, the keypoint module 310 and the multi-stage modules 305 comprise a feedforward neural network (i.e. the first neural network 202) that takes as input an RGB image of size w×h×3 and branches to produce two different outputs such as, e.g., belief maps. In an embodiment, w=640 and h=480. The stages of belief map units 315 operate serially, with each stage (belief map unit 315) taking into account not only the image features but also the outputs of the immediately preceding stage.

Stages of belief map units 315 within each multi-stage module 305 generate a belief map for estimation of a single 2D location associated with the object in the image. A first belief map comprises probability values for a centroid of the object and additional belief maps comprise probability values for the vertices of a bounding volume that encloses the object.

In an embodiment, the 2D locations of detected vertices are 2D coordinates of 3D bounding vertices that each enclose an object and are projected into image space in the scene. By representing each object by a 3D bounding box, an abstract representation of each object is defined that is sufficient for pose estimation yet independent of the details of the object's shape. When the bounding volume is a 3D bounding box, nine multi-stage modules 305 may be used to generate belief maps for the centroid and eight vertices in parallel. The pose unit 325 estimates the 2D coordinates of the 3D bounding box vertices projected into image space and then infers the object location and pose in 3D space from perspective-n-point (PnP), using either traditional computer vision algorithms or another neural network. PnP estimates the pose of an object using a set of n locations in 3D space and projections of the n locations in image space. In an embodiment, the pose estimation system 300 estimates, in real time, the 3D poses of known objects within clutter from a single RGB image.

In an embodiment, the stages of belief map units 315 are each convolutional neural network (CNN) stages. When each stage is a CNN, each stage leverages an increasingly larger effective receptive field as data is passed through the neural network. This property enables the stages of belief map units 315 to resolve ambiguities by incorporating increasingly larger amounts of context in later stages.

In an embodiment, the stages of belief map units 315 receive 128-dimensional features extracted by the keypoint module 310. In an embodiment, the belief map unit 315-1 comprises three 3×3×128 layers and one 1×1×512 layer. In an embodiment, the belief map unit 315-2 is a 1×1×9 layer. In an embodiment, the belief map units 315-3 through 315-T are identical to the first stages, except that each receives a 153—dimensional input (128+16+9=153) and includes five 7×7×128 layers and one 1×1×128 layer before the 1×1×128 or 1×1×16 layer. In an embodiment, each of the belief map units 315 are of size _{w/8} and _{h/8}, with rectified linear unit (ReLU) activation functions interleaved throughout.

FIG. 4 illustrates a block diagram associated with use of the second neural network 204 of FIG. 2, in accordance with an embodiment. Of course, the block diagram is set forth as one possible embodiment associated with the second neural network 204 of FIG. 2. This embodiment related the second neural network 204 is described in more detail in U.S. application Ser. No. 16/657,220 (Reference: 1R2674.006901/19-SE-0341US01), filed Oct. 18, 2019 and entitled “POSE DETERMINATION USING ONE OR MORE NEURAL NETWORKS,” which is herein incorporated by reference in its entirety.

As shown, a captured image 402 of a robot is provided as input to a trained neural network 204. It should be noted that while a robot is described in the context of the present embodiment, the block diagram described herein may equally be applied to other objects (e.g. other autonomous systems). As an option, some pre-processing or augmentation of this image may be performed, such as to adjust a resolution, color depth, or contrast before processing. In at least one embodiment, network 204 can be trained specifically for a type of robot 204, as different robots can have different shapes, sizes, configurations, kinematics, and features.

In use, neural network 204 can analyze input image 402 and output, as a set of inferences, a set of belief maps 406. As an option, other dimension determination inferences can be generated for locating feature points. For example, neural network 204 can infer one belief map 406 for each robot feature to be identified.

In at least one embodiment, a model of a robot used for training can identify specific features to be tracked. These features can be learned through a training process. In another embodiment, features can be located on different movable portions or components of a robot such that a pose of that robot can be determined from those features. In a further embodiment, features can be selected such that each pose of a robot corresponds to one and only one configuration of features, and each configuration of features corresponds to one and only one robot pose. This uniqueness may enable camera-to-robot pose to be determined based upon a unique orientation of features as represented in captured image data.

With respect to the network 204, an auto-encoder network can detect key points. In at least one embodiment, the neural network 204 takes as input an RGB image of size w×h×3, and outputs n belief maps 406 having a form w×h×n. In at least one embodiment, an RGBD or stereoscopic image can be taken as input as well. Optionally, w=640 and h=480. In at least one embodiment, output for each key point is a 2D belief map, where pixel values represent a likelihood that a key point is projected onto that pixel.

In one embodiment, an encoder of the network 204 consists of convolutional layers of VGG-19 pre-trained on ImageNet. In another embodiment, a ResNet-based encoder can be used. In a further embodiment, a decoder or up-sampling component of the network 204 is composed of four 2D transpose convolutional layers, with each layer being followed by a normal 3×3 convolutional layer and ReLU activation layer. Further still, an output head may be composed of three convolutional layers (3×3, stride=1, padding=1) with ReLU activations with 64, 32, and n channels, respectively. In at least one embodiment, there may be no activation layer after a final convolutional layer. In another embodiment, an encoder network may be trained using an L2 loss function comparing output belief maps with ground truth belief maps, where ground truth belief maps are generated using σ=2 pixels for generating peaks. In at least one embodiment, use of stereoscopic image pairs may allow for poses estimated by these images to be fused, or a point cloud may be computed and pose determined using a process such as Procrustes analysis or iterative closest point (ICP).

In at least one embodiment, belief maps 406 can be provided as input to a peak extraction component 408, or service, that is able to determine a set of coordinates in two dimensions that represents positions of relevant robot features. As an option, key point coordinates may be calculated as a weighted average of values near thresholded peaks in respective belief maps, after first applying Gaussian smoothing to these belief maps to reduce noise effects. This weighted average may allow for subpixel precision. In at least one embodiment, these two-dimensional coordinates (or pixel locations) can be provided as input to a pose determination module, such as a perspective-n-point (PnP) module 414. This pose determination module may also accept as input camera intrinsics data 410, such as calibration information for a camera that can be used to account for image artifacts due to lens asymmetries, focal length, principal point, or other such factors.

In at least one embodiment, this pose determination module can also receive as input information about forward kinematics 412 for this type of robot, in order to determine possible poses. Kinematics may be used to narrow a search space where only certain feature locations are possible due to physical configuration or limitations of this type of robot. This information may be analyzed using a PnP algorithm to output a determined camera-to-robot pose. In at least one embodiment, perspective-n-point is used to recover camera extrinsics, assuming that a joint configuration of this robot manipulator is known. This pose information can be used to determine a relative distance and orientation between a camera and a robot, as a base coordinate or other feature of this robot can be accurately identified in a camera space, or camera coordinate system. To this end, the neural network 204 may be trained to be able to infer positions of these features, such as by inferring the set of belief maps 406.

In at least one embodiment, relative position and orientation information can be used to ensure that a camera coordinate space from a point of view of the camera is aligned with a robot coordinate space of robot, both in dimension and alignment. In at least one embodiment, an inaccurate orientation or position of camera 502 with respect to robot 504 can result in incorrect coordinates being given for robot 504 to perform an action, as these coordinates may be correct from a camera coordinate system but not in a robot coordinate system. To this end, a relative position and orientation of camera 502 can be determined with respect to robot 504. In at least one embodiment, relative position of camera 502 may be sufficient, while orientation information can be useful depending upon factors such as camera intrinsic, where asymmetric image properties can impact accuracy if not properly accounted for. This relative position/orientation may be calibrated online (e.g. during runtime of the robot).

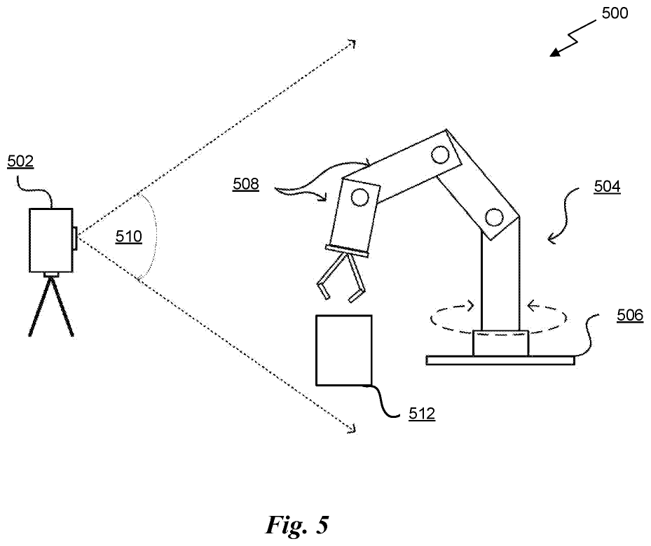

FIG. 5 illustrates a robotic grasping system 500 controlled using a robot-to-object pose estimation system, in accordance with an embodiment. The robotic grasping system 500 may be implemented on the context of the previously described embodiments.

As shown, a camera 502 might be used to capture images, possibly in the form of video frames, of an autonomous object, such as a robot 504. The camera 502 may be positioned, or externally mounted, such that robot 504 is within a field of view 510 of camera 502, and camera 502 can capture the image, which may include at least a partial representation, if not a full view representation, of robot 504. The captured image can be used to help provide instructions to robot 504 to perform a specific task.

In at least one embodiment, the captured image may be analyzed to determine a location of an object 512 relative to robot 504, with which robot 504 is to interact in some way, such as to pick up or modify this object 512. In particular, the system 200 of FIG. 2 may be utilized to determine the robot-to-object pose for purposes of providing robot 504, or a control system for robot 504, with accurate instructions. The robot-to-object pose may be used for other purposes as well, such as to help navigate robot 504 or provide current information about a state of robot 504. In at least one embodiment, accurate position and orientation data between the robot 504 and the object 512 enables robot 504 to operate robustly in unstructured, dynamic environments, performing tasks such as object grasping and manipulation, human-robot interaction, and collision detection and avoidance. Thus, it may be desired to determine at least one of a position or an orientation of robot 504 relative to camera 502 and object 512 relative to camera 502, to then determine the robot-to-object pose.

As noted above, an image can be captured by camera 502 that illustrates a current orientation of robot 504 with respect to camera 502 and a current orientation of object 512 with respect to camera 502. With respect to the orientation of robot 504, robot 504 can have various articulated limbs 508 or components, such that robot 504 can be in various configurations or “poses.” In at least one embodiment, different poses of robot 504 can result in different representations in images captured by camera 502. In at least one embodiment, a single image captured by camera 502 can be analyzed to determine features of robot 504 that can be used to determine a pose of robot 504. The features can correspond to joints or locations at which a robot can move or make adjustments in position or orientation. Further, since dimensions and kinematics of robot 504 are known, determining a pose of robot 504 from a perspective of camera 502 can enable an accurate determination of camera-to-robot distance and orientation.

### Machine Learning

Deep neural networks (DNNs), including deep learning models, developed on processors have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions. Inferencing is less compute-intensive than training, being a latency-sensitive process where a trained neural network is applied to new inputs it has not seen before to classify images, translate speech, and generally infer new information.

### Inference and Training Logic

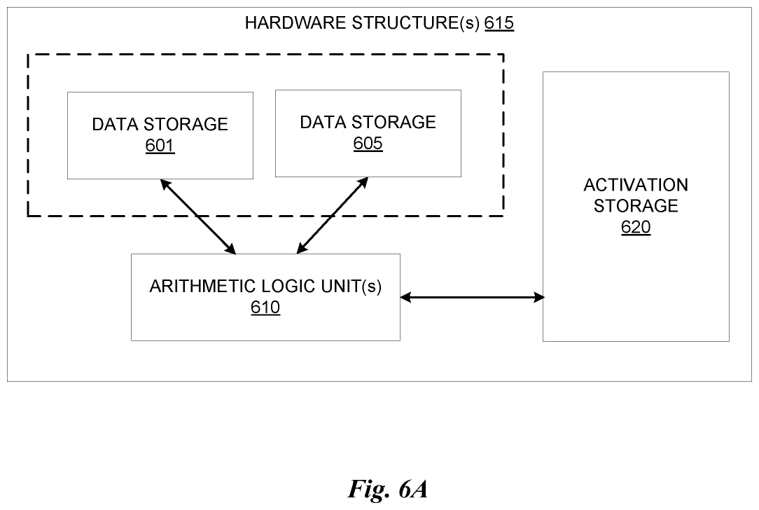

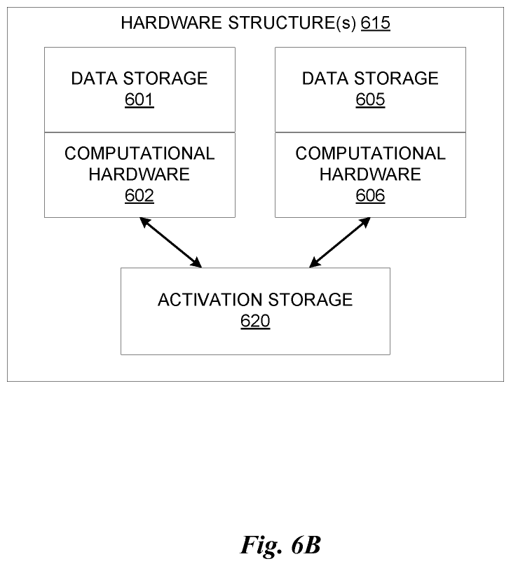

As noted above, a deep learning or neural learning system needs to be trained to generate inferences from input data. Details regarding inference and/or training logic 615 for a deep learning or neural learning system are provided below in conjunction with FIGS. 6A and/or 6B.

In at least one embodiment, inference and/or training logic 615 may include, without limitation, a data storage 601 to store forward and/or output weight and/or input/output data corresponding to neurons or layers of a neural network trained and/or used for inferencing in aspects of one or more embodiments. In at least one embodiment data storage 601 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of data storage 601 may be included with other on-chip or off-chip data storage, including a processor's L1, L2, or L3 cache or system memory.

In at least one embodiment, any portion of data storage 601 may be internal or external to one or more processors or other hardware logic devices or circuits. In at least one embodiment, data storage 601 may be cache memory, dynamic randomly addressable memory (“DRAM”), static randomly addressable memory (“SRAM”), non-volatile memory (e.g., Flash memory), or other storage. In at least one embodiment, choice of whether data storage 601 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 615 may include, without limitation, a data storage 605 to store backward and/or output weight and/or input/output data corresponding to neurons or layers of a neural network trained and/or used for inferencing in aspects of one or more embodiments. In at least one embodiment, data storage 605 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, any portion of data storage 605 may be included with other on-chip or off-chip data storage, including a processor's L1, L2, or L3 cache or system memory. In at least one embodiment, any portion of data storage 605 may be internal or external to on one or more processors or other hardware logic devices or circuits. In at least one embodiment, data storage 605 may be cache memory, DRAM, SRAM, non-volatile memory (e.g., Flash memory), or other storage. In at least one embodiment, choice of whether data storage 605 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, data storage 601 and data storage 605 may be separate storage structures. In at least one embodiment, data storage 601 and data storage 605 may be same storage structure. In at least one embodiment, data storage 601 and data storage 605 may be partially same storage structure and partially separate storage structures. In at least one embodiment, any portion of data storage 601 and data storage 605 may be included with other on-chip or off-chip data storage, including a processor's L1, L2, or L3 cache or system memory.

In at least one embodiment, inference and/or training logic 615 may include, without limitation, one or more arithmetic logic unit(s) (“ALU(s)”) 610 to perform logical and/or mathematical operations based, at least in part on, or indicated by, training and/or inference code, result of which may result in activations (e.g., output values from layers or neurons within a neural network) stored in an activation storage 620 that are functions of input/output and/or weight parameter data stored in data storage 601 and/or data storage 605. In at least one embodiment, activations stored in activation storage 620 are generated according to linear algebraic and or matrix-based mathematics performed by ALU(s) 610 in response to performing instructions or other code, wherein weight values stored in data storage 605 and/or data 601 are used as operands along with other values, such as bias values, gradient information, momentum values, or other parameters or hyperparameters, any or all of which may be stored in data storage 605 or data storage 601 or another storage on or off-chip. In at least one embodiment, ALU(s) 610 are included within one or more processors or other hardware logic devices or circuits, whereas in another embodiment, ALU(s) 610 may be external to a processor or other hardware logic device or circuit that uses them (e.g., a co-processor). In at least one embodiment, ALUs 610 may be included within a processor's execution units or otherwise within a bank of ALUs accessible by a processor's execution units either within same processor or distributed between different processors of different types (e.g., central processing units, graphics processing units, fixed function units, etc.). In at least one embodiment, data storage 601, data storage 605, and activation storage 620 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 620 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 620 may be cache memory, DRAM, SRAM, non-volatile memory (e.g., Flash memory), or other storage. In at least one embodiment, activation storage 620 may be completely or partially within or external to one or more processors or other logical circuits. In at least one embodiment, choice of whether activation storage 620 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 615 illustrated in FIG. 6A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 615 illustrated in FIG. 6A may be used in conjunction with central processing unit (“CPU”) hardware, graphics processing unit (“GPU”) hardware or other hardware, such as field programmable gate arrays (“FPGAs”).

FIG. 6B illustrates inference and/or training logic 615, according to at least one embodiment. In at least one embodiment, inference and/or training logic 615 may include, without limitation, hardware logic in which computational resources are dedicated or otherwise exclusively used in conjunction with weight values or other information corresponding to one or more layers of neurons within a neural network. In at least one embodiment, inference and/or training logic 615 illustrated in FIG. 6B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 615 illustrated in FIG. 6B may be used in conjunction with central processing unit (CPU) hardware, graphics processing unit (GPU) hardware or other hardware, such as field programmable gate arrays (FPGAs). In at least one embodiment, inference and/or training logic 615 includes, without limitation, data storage 601 and data storage 605, which may be used to store weight values and/or other information, including bias values, gradient information, momentum values, and/or other parameter or hyperparameter information. In at least one embodiment illustrated in FIG. 6B, each of data storage 601 and data storage 605 is associated with a dedicated computational resource, such as computational hardware 602 and computational hardware 606, respectively. In at least one embodiment, each of computational hardware 606 comprises one or more ALUs that perform mathematical functions, such as linear algebraic functions, only on information stored in data storage 601 and data storage 605, respectively, result of which is stored in activation storage 620.

In at least one embodiment, each of data storage 601 and 605 and corresponding computational hardware 602 and 606, respectively, correspond to different layers of a neural network, such that resulting activation from one “storage/computational pair 601/602” of data storage 601 and computational hardware 602 is provided as an input to next “storage/computational pair 605/606” of data storage 605 and computational hardware 606, in order to mirror conceptual organization of a neural network. In at least one embodiment, each of storage/computational pairs 601/602 and 605/606 may correspond to more than one neural network layer. In at least one embodiment, additional storage/computation pairs (not shown) subsequent to or in parallel with storage computation pairs 601/602 and 605/606 may be included in inference and/or training logic 615.

### Neural Network Training and Deployment

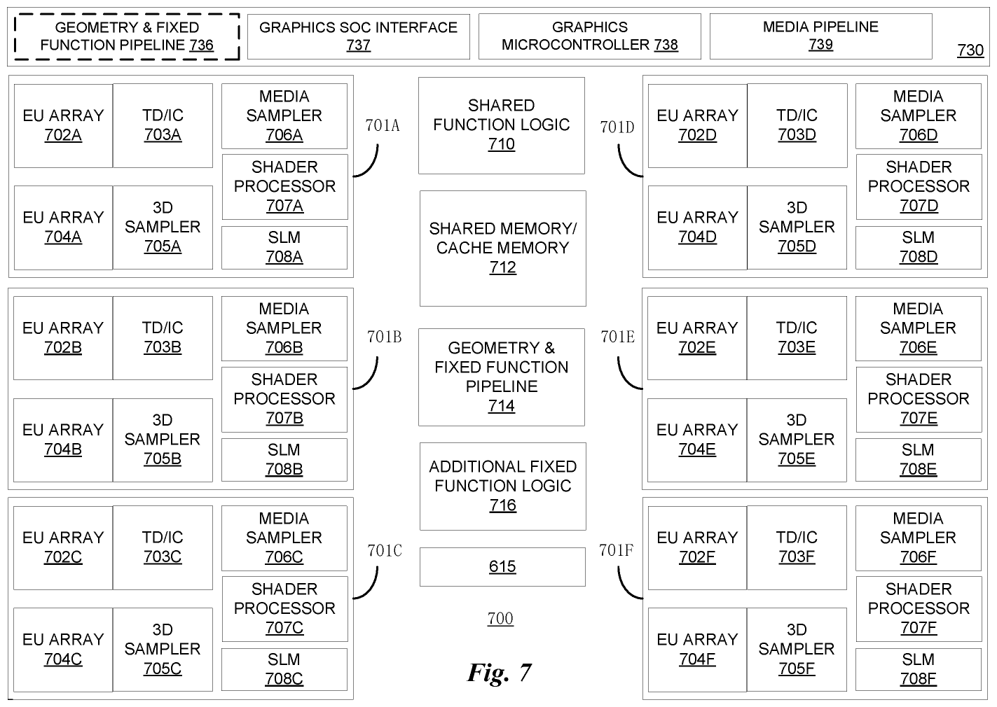

FIG. 7 illustrates another embodiment for training and deployment of a deep neural network. In at least one embodiment, untrained neural network 706 is trained using a training dataset 702. In at least one embodiment, training framework 704 is a PyTorch framework, whereas in other embodiments, training framework 704 is a Tensorflow, Boost, Caffe, Microsoft Cognitive Toolkit/CNTK, MXNet, Chainer, Keras, Deeplearning4j, or other training framework. In at least one embodiment training framework 704 trains an untrained neural network 706 and enables it to be trained using processing resources described herein to generate a trained neural network 708. In at least one embodiment, weights may be chosen randomly or by pre-training using a deep belief network. In at least one embodiment, training may be performed in either a supervised, partially supervised, or unsupervised manner.

In at least one embodiment, untrained neural network 706 is trained using supervised learning, wherein training dataset 702 includes an input paired with a desired output for an input, or where training dataset 702 includes input having known output and the output of the neural network is manually graded. In at least one embodiment, untrained neural network 706 is trained in a supervised manner processes inputs from training dataset 702 and compares resulting outputs against a set of expected or desired outputs. In at least one embodiment, errors are then propagated back through untrained neural network 706. In at least one embodiment, training framework 704 adjusts weights that control untrained neural network 706. In at least one embodiment, training framework 704 includes tools to monitor how well untrained neural network 706 is converging towards a model, such as trained neural network 708, suitable to generating correct answers, such as in result 714, based on known input data, such as new data 712. In at least one embodiment, training framework 704 trains untrained neural network 706 repeatedly while adjust weights to refine an output of untrained neural network 706 using a loss function and adjustment algorithm, such as stochastic gradient descent. In at least one embodiment, training framework 704 trains untrained neural network 706 until untrained neural network 706 achieves a desired accuracy. In at least one embodiment, trained neural network 708 can then be deployed to implement any number of machine learning operations.

In at least one embodiment, untrained neural network 706 is trained using unsupervised learning, wherein untrained neural network 706 attempts to train itself using unlabeled data. In at least one embodiment, unsupervised learning training dataset 702 will include input data without any associated output data or “ground truth” data. In at least one embodiment, untrained neural network 706 can learn groupings within training dataset 702 and can determine how individual inputs are related to untrained dataset 702. In at least one embodiment, unsupervised training can be used to generate a self-organizing map, which is a type of trained neural network 708 capable of performing operations useful in reducing dimensionality of new data 712. In at least one embodiment, unsupervised training can also be used to perform anomaly detection, which allows identification of data points in a new dataset 712 that deviate from normal patterns of new dataset 712.

In at least one embodiment, semi-supervised learning may be used, which is a technique in which in training dataset 702 includes a mix of labeled and unlabeled data. In at least one embodiment, training framework 704 may be used to perform incremental learning, such as through transferred learning techniques. In at least one embodiment, incremental learning enables trained neural network 708 to adapt to new data 712 without forgetting knowledge instilled within network during initial training.

### Data Center

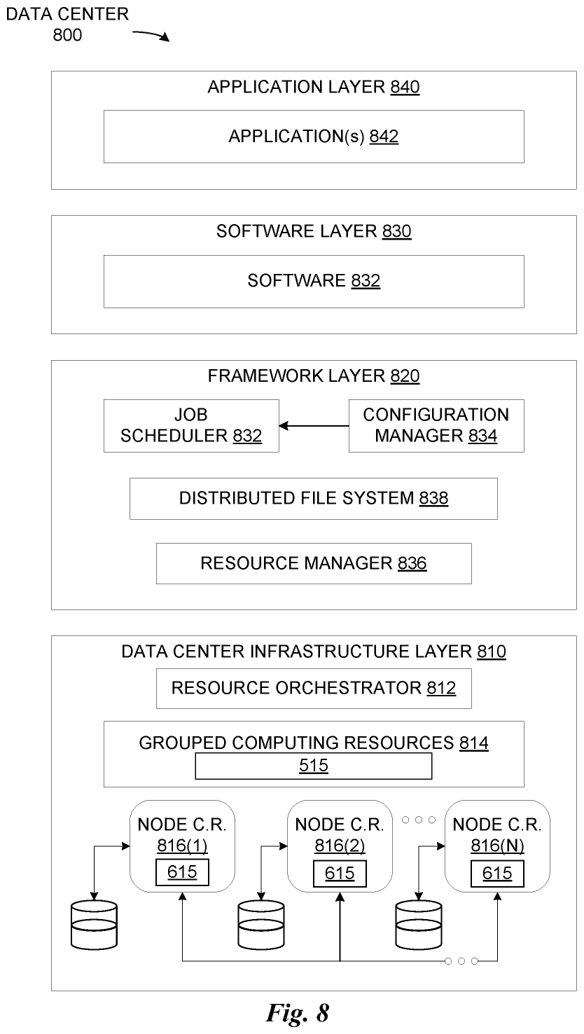

FIG. 8 illustrates an example data center 800, in which at least one embodiment may be used. In at least one embodiment, data center 800 includes a data center infrastructure layer 810, a framework layer 820, a software layer 830 and an application layer 840.

In at least one embodiment, as shown in FIG. 8, data center infrastructure layer 810 may include a resource orchestrator 812, grouped computing resources 814, and node computing resources (“node C.R.s”) 816(1)-816(N), where “N” represents any whole, positive integer. In at least one embodiment, node C.R.s 816(1)-816(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 816(1)-816(N) may be a server having one or more of above-mentioned computing resources.

In at least one embodiment, grouped computing resources 814 may include separate groupings of node C.R.s housed within one or more racks (not shown), or many racks housed in data centers at various geographical locations (also not shown). Separate groupings of node C.R.s within grouped computing resources 814 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 822 may configure or otherwise control one or more node C.R.s 816(1)-816(N) and/or grouped computing resources 814. In at least one embodiment, resource orchestrator 822 may include a software design infrastructure (“SDI”) management entity for data center 800. In at least one embodiment, resource orchestrator may include hardware, software or some combination thereof.

In at least one embodiment, as shown in FIG. 8, framework layer 820 includes a job scheduler 832, a configuration manager 834, a resource manager 836 and a distributed file system 838. In at least one embodiment, framework layer 820 may include a framework to support software 832 of software layer 830 and/or one or more application(s) 842 of application layer 840. In at least one embodiment, software 832 or application(s) 842 may respectively include web-based service software or applications, such as those provided by Amazon Web Services, Google Cloud and Microsoft Azure. In at least one embodiment, framework layer 820 may be, but is not limited to, a type of free and open-source software web application framework such as Apache Spark™ (hereinafter “Spark”) that may utilize distributed file system 838 for large-scale data processing (e.g., “big data”). In at least one embodiment, job scheduler 832 may include a Spark driver to facilitate scheduling of workloads supported by various layers of data center 800. In at least one embodiment, configuration manager 834 may be capable of configuring different layers such as software layer 830 and framework layer 820 including Spark and distributed file system 838 for supporting large-scale data processing. In at least one embodiment, resource manager 836 may be capable of managing clustered or grouped computing resources mapped to or allocated for support of distributed file system 838 and job scheduler 832. In at least one embodiment, clustered or grouped computing resources may include grouped computing resource 814 at data center infrastructure layer 810. In at least one embodiment, resource manager 836 may coordinate with resource orchestrator 812 to manage these mapped or allocated computing resources.

In at least one embodiment, software 832 included in software layer 830 may include software used by at least portions of node C.R.s 816(1)-816(N), grouped computing resources 814, and/or distributed file system 838 of framework layer 820. one or more types of software may include, but are not limited to, Internet web page search software, e-mail virus scan software, database software, and streaming video content software.

In at least one embodiment, application(s) 842 included in application layer 840 may include one or more types of applications used by at least portions of node C.R.s 816(1)-816(N), grouped computing resources 814, and/or distributed file system 838 of framework layer 820. one or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 834, resource manager 836, and resource orchestrator 812 may implement any number and type of self-modifying actions based on any amount and type of data acquired in any technically feasible fashion. In at least one embodiment, self-modifying actions may relieve a data center operator of data center 800 from making possibly bad configuration decisions and possibly avoiding underutilized and/or poor performing portions of a data center.

In at least one embodiment, data center 800 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 800. In at least one embodiment, trained machine learning models corresponding to one or more neural networks may be used to infer or predict information using resources described above with respect to data center 800 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 615 are used to perform inferencing and/or training operations associated with one or more embodiments. In at least one embodiment, inference and/or training logic 615 may be used in system FIG. 8 for inferencing or predicting operations based, at least in part, on weight parameters calculated using neural network training operations, neural network functions and/or architectures, or neural network use cases described herein.

As described herein, a method, computer readable medium, and system are disclosed for estimating an object-to-object pose using an externally captured image of the objects. In accordance with FIGS. 1-4, an embodiment may provide neural networks usable for performing inferencing operations and for providing inferenced data, where the neural networks are stored (partially or wholly) in one or both of data storage 601 and 605 in inference and/or training logic 615 as depicted in FIGS. 6A and 6B. Training and deployment of the neural networks may be performed as depicted in FIG. 7 and described herein. Distribution of the neural networks may be performed using one or more servers in a data center 800 as depicted in FIG. 8 and described herein.

What is claimed is:

1. A method, comprising:
identifying an image of a first object and a target object, the image captured by a camera external to the first object and the target object;
processing the image, using a first neural network, to estimate a first pose of the target object with respect to the camera;
processing the image, using a second neural network, to estimate a second pose of the first object with respect to the camera; and
calculating a third pose of the first object with respect to the target object, using the first pose and the second pose.

2. The method of claim 1, wherein the image is a red-green-blue (RGB) image or a grayscale image.

3. The method of claim 1, wherein the camera captures one of wavelengths of light or non-light wavelengths.

4. The method of claim 1, wherein the first object is a robotic grasping system.

5. The method of claim 4, wherein the target object is a known object to be grasped by the robotic grasping system.

6. The method of claim 5, further comprising:
causing the robotic grasping system to grasp the known object, using the third pose.

7. The method of claim 1, wherein the first pose of the target object with respect to the camera includes a three-dimensional (3D) rotation and translation of the target object with respect to the camera.

8. The method of claim 1, wherein the second pose of the first object with respect to the camera includes a 3D rotation and translation of the first object with respect to the camera.

9. The method of claim 1, wherein the second neural network performs online calibration of the camera.

10. The method of claim 1, wherein the third pose is a pose of the target object with respect to a coordinate frame of the first object.

11. The method of claim 1, wherein only the first neural network is trained for the target object.

12. The method of claim 1, wherein only the second neural network is trained for the first object.

13. The method of claim 1, further comprising:
refining the first pose, and
refining the second pose.

14. The method of claim 13, wherein refining the first pose is performed by:
iteratively matching the image with a synthetic projection of a model according to the first pose and adjusting parameters of the first pose based on a result of the iterative matching.

15. The method of claim 13, wherein refining the second pose is performed by:
iteratively matching the image with a synthetic projection of a model according to the second pose and adjusting parameters of the second pose based on a result of the iterative matching.

16. A non-transitory computer-readable medium storing computer instructions that, when executed by one or more processors, cause the one or more processors to perform a method comprising:
identifying an image of a first object and a target object, the image captured by a camera external to the first object and the target object;
processing the image, using a first neural network, to estimate a first pose of the target object with respect to the camera;
processing the image, using a second neural network, to estimate a second pose of the first object with respect to the camera; and
calculating a third pose of the first object with respect to the target object, using the first pose and the second pose.

17. A system, comprising:
a first neural network that receives as input an image of a first object and a target object and processes the image to estimate a first pose of the target object with respect to the camera, wherein the image is captured by a camera external to the first object and the target object;
a second neural network that receives as input the image and processes the image to estimate a second pose of the first object with respect to the camera; and
a processor that calculates a third pose of the first object with respect to the target object, using the first pose and the second pose.

18. The system of claim 17, wherein the camera is external to the system.

19. The system of claim 17, wherein the first object is a robotic grasping system and the target object is a known object.

20. The system of claim 19, wherein the processor causes the robotic grasping system to grasp the target object, using the third pose.
